(19) United States
(12) Patent Application Publication
(10) Pub. No.: US 2013/0052487 A1
(43) Pub. Date: Feb. 28, 2013

(54) BATTERY PACK

(71) Applicant: Han-Kyu Park, Yongin-si (KR)

(72) Inventor: Han-Kyu Park, Yongin-si (KR)

(73) Assignee: Samsung SDI Co., Ltd., Yongin-si (KR)

(21) Appl. No.: 13/559,446

(22) Filed: Jul. 26, 2012

Related U.S. Application Data
(60) Provisional application No. 61/529,779, filed on Aug. 31, 2011.

(51) Int. Cl. H01M 10/42; H01M 2/22

(52) U.S. Cl. 429/7; 429/159

(57) ABSTRACT

Disclosed is a battery pack having improved durability and safety. The battery pack according to the present invention includes: a plurality of battery cells having a first electrode and a second electrode and disposed substantially parallel with each other in a first direction; a holder case accommodating the battery cells; a lead wire connected to the battery cells; and at least one connection tab including a connection part connected to at least one of the first electrode and the second electrode of the battery cells, an extension part extending from the connection part, and a guide part having a guide groove accommodating the lead wire in.

### CROSS REFERENCE TO RELATED APPLICATIONS

This application claims the benefit of U.S. Provisional Patent Application No. 61/529779 filed Aug. 31, 2011 which is hereby incorporated by reference in its entirety.

### BACKGROUND

1. Field of the Invention

The embodiment relates to a battery pack, more particularly to a battery pack having improved durability and safety.

2. Discussion of Related Art

In general, a battery pack composed of a plurality of battery cells connected in parallel and/or in series is used for devices, such as laptops and electric vehicles. The battery cells are connected by connecting adjacent battery cells using connection tabs. Further, the battery cells are mounted in a case.

### SUMMARY OF THE INVENTION

One embodiment of the present invention is to provide a battery pack in which a guide part is formed on a connection tab mounted on an external side of a plurality of battery cells to fix the battery cells, thereby improving durability and safety.

One embodiment of the present invention is to provide a battery pack which improves workability of a welding process, facilitates identification of an unwelded portion in the welding process, and secures a design margin when coupling the battery pack with an external case.

According to an aspect of the present invention, there is provided a battery pack that includes: a plurality of battery cells having a first electrode and a second electrode and disposed substantially parallel with each other in a first direction; a holder case accommodating the battery cells; a lead wire connected to the battery cells; and at least one connection tab including a connection part connected to at least one of the first electrode and the second electrode of the battery cells, an extension part extending from the connection part, and a guide part having a guide groove accommodating the lead wire in.

The battery pack may further include a protection circuit module mounted on the holder case, and the battery cells may be connected to the protection circuit module through at least one lead wire.

A bent part which is bent to accommodate the lead wire in the first direction may be formed on a boundary between the extension part and the guide part of the connection tab, and a through hole to pass the lead wire through may be formed in a portion in which the guide groove starts from the bent part.

The bent part may have a bent groove to facilitate bending.

A part of the lead wire is disposed to face one side of the guide part facing the battery cells, and another part of the lead wire connected to the part of the lead wire passes through the through hole, is bent, is accommodated in the guide groove, and is welded.

The through hole may have a through hole cover covering at least part of the through hole provided in a direction of the extension part, and the through hole cover may extrude outwards.

The guide groove may have a corresponding shape to the lead wire and may have a narrow entrance so that a lead wire is forcibly inserted into the guide groove.

Further, a protrusion rib may be formed around the guide groove to prevent horizontal movement of the lead wire, and the protrusion rib may be formed to extend in a lengthwise direction of the guide groove.

The guide groove may be formed such that a portion corresponding to a cover surrounding the lead wire has a first area as a portion corresponding to the lead wire has a second area.

An insulating sheet may be provided on the connection tab.

The battery pack may further include an external case provided around the holder case to cover the battery cells, and the external case may include a first case and a second case, which are coupled to each other.

According to another embodiment of the present invention, a battery pack includes a guide part formed on a connection tab mounted on an external side of a plurality of battery cells to fix battery cells and a lead wire, thereby improving durability and safety.

Further, a welding process is conducted over the battery pack, thereby improving workability of the welding process.

Accordingly, it is easy to identify an unwelded part in the welding process, and a design margin is secured when combining the battery pack with an external case.

In another embodiment, the present invention comprises a battery pack comprising a plurality of battery cells having a first electrode and a second electrode that are disposed parallel to each other in a first direction. In this embodiment, the battery pack further comprises a holder that receives the plurality of battery cells and at least one lead wire that is coupled to the plurality of battery cells. In this embodiment, the battery pack further comprises at least one connection tab that is electrically connected to at least some of the plurality of battery cells, wherein the connection tab has an extension part that comprises a guide groove that receive the at least one lead wire.

In another embodiment, the invention may comprise a battery pack comprising a plurality of battery cells having a first electrode and a second electrode that are disposed parallel to each other in a first direction. The battery pack may further comprise a holder that receives the plurality of battery cells and a plurality of lead wires that are coupled to the plurality of battery cells. In this embodiment, the battery pack may further comprise a plurality of connection tabs that are electrically connected to the first and second electrodes of the plurality of battery cells, wherein each of the connection tabs have an extension part that defines a guide groove that receives one of the lead wires. In this embodiment, the battery pack may further comprise a protection circuit board that is mounted adjacent the holder and receives the plurality of lead wires from the battery and an external case that receives the plurality of batteries, the older and the connection tabs.

### BRIEF DESCRIPTION OF THE DRAWINGS

The accompanying drawings, together with the specification, illustrate exemplary embodiments of the present invention, and, together with the description, serve to explain the principles of the present invention.

FIG. 1A is a front perspective view showing that a holder case is mounted on a plurality of battery cells according to an embodiment of the present invention;

FIG. 1B is a rear perspective view showing that the holder case is mounted on the battery cells according to the embodiment of the present invention;

FIG. 2 is an enlarged perspective view of a connection tab according to a first embodiment of the present invention;

FIGS. 3A to 3C are partial perspective views illustrating a process of accommodating a lead wire in the connection tab according to the first embodiment of the present invention;

FIG. 4A is an enlarged perspective view of a connection tab according to a second embodiment of the present invention;

FIG. 4B is an enlarged perspective view of a connection tab according to a third embodiment of the present invention;

FIG. 5A is an enlarged perspective view of a connection tab according to a fourth embodiment of the present invention;

FIG. 5B is an enlarged perspective view of a connection tab according to a fifth embodiment of the present invention;

FIG. 5C is an enlarged perspective view of a connection tab according to a sixth embodiment of the present invention; and

FIG. 6 is a perspective view showing a battery pack including an external case according to another embodiment the present invention.

### DETAILED DESCRIPTION OF THE INVENTION

Reference will now be made in detail to exemplary embodiments of the present invention, examples of which are illustrated in the accompanying drawings. The embodiments are described below in order to explain the present invention by referring to the figures. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art.

Description of unnecessary parts or elements may be omitted for clarity and conciseness, and like reference numerals refer to like elements throughout. In the drawings, the size and relative sizes of layers and regions may be exaggerated for clarity.

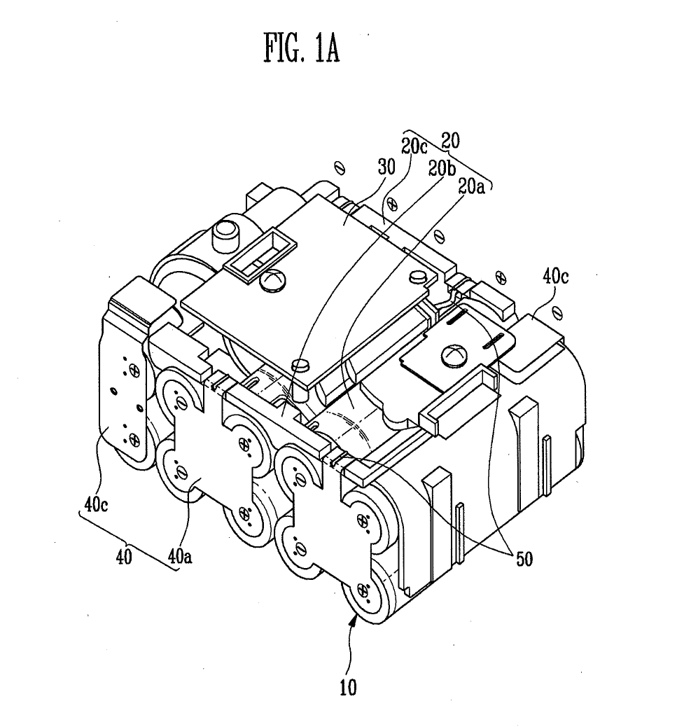

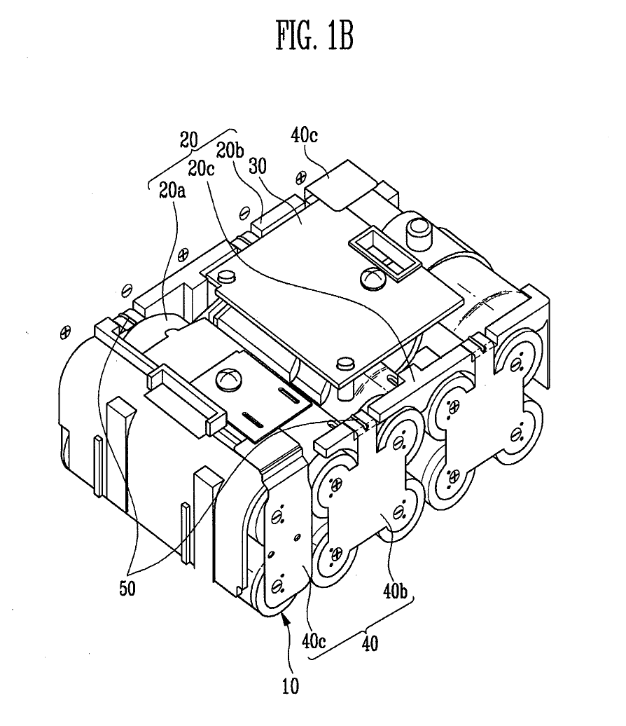

FIG. 1A is a front perspective view showing that a holder case is mounted on a plurality of battery cells according to an embodiment of the present invention, and FIG. 1B is a rear perspective view showing that the holder case is mounted on the battery cells according to the embodiment of the present invention.

Referring to FIGS. 1A and 1B, a battery pack according to an embodiment of the present invention includes a plurality of battery cells 10, a holder case 20, a protection circuit module 30, a connection tab 40, and a lead wire 50.

First, the battery cells 10 in one embodiment are chargeable/dischargeable cylindrical lithium ion batteries. The battery cells 10 according to the embodiment of the present invention are arranged in a five-series and two-parallel structure (e.g., 5S*2P). That is, five battery cell groups, each of which has a set of two battery cells connected in parallel, are connected in series by connection tabs 40. The connection tabs 40 are formed of a conductive element, such as copper, and electrically connect the battery cell groups.

Basically, two battery cells are connected in parallel. One end of the battery cells connected in parallel is a first electrode having a first polarity, and the other end thereof is a second electrode having a second polarity. In FIG. 1A, the first electrodes of the battery cells are electrically connected to the protection circuit module 30 by the connection tab 40c. In FIG. 1B, the second electrodes having the second polarity are electrically connected in series to first electrodes of adjacent battery cells through the connection tab 40b. In this manner, total five groups of battery cells 10 are connected in series, and the second electrodes of the last battery cells 10 are electrically connected to the protection circuit module 30 through the connection tab 40c. Although the five-series and two-parallel structure (5S*2P) are illustrated in the present embodiment as an example, the present invention is not limited thereto, and various connection structures may be employed if needed without departing from the present invention.

Here, the holder case 20 may be formed to cover at least part of an external side of the battery cells 10. An end portion of the holder case 20 may be formed to match a circumferential surface of the cylindrical battery cells 10, thereby inhibiting the battery cells from moving by external impact.

Referring to FIG. 1A, a guide part 47 may be formed on a first extender 20b in a position corresponding to a position of the connection tab 40a. Referring to FIG. 1B, the guide part 47 may be formed on a second extender 20c in a position corresponding to a position of the connection tab 40b. That is, the first extender 20b extending from a cover 20a of the holder case 20 is positioned at one end of the battery cells 10, and the second extender 20c is positioned at the other end of the battery cells 10.

As described above, the battery pack includes the connection tabs 40 connected to at least one of the first electrode and the second electrode of the battery cells 10. Referring to FIG. 2, a connection tab 40 according to a first embodiment of the present invention includes a connection part 41 connected to at least one of the first electrode and the second electrode of the battery cells 10, an extension part 43 extending from the connection part 41, and a guide part 47 formed with a guide groove 47a accommodating a lead wire. Further, the connection tab 40 includes a bent part 45 formed on a boundary between the extension part 43 and the guide part 47 of the connection tab 40. A through hole 45b to pass the lead wire 50 through is formed in a portion in which the guide groove 47a starts from the bent part 45. The bent part 45 may have a bent groove 45a, which facilitates bending of the bent part 45. The bent groove 45a may be in a concave form formed on a relatively large area, for example, in a relatively thin line formed by pressing using the back or the blade of a knife, without being limited thereto.

The position where the guide part 47 is formed may form a zigzag shape, when seeing the holder case 20 from above. That is, the guide parts 47 of the present invention may be formed on the first extender 20b and the second extender 20c while being positioned on a plurality of connection tabs 40a, 40b, and 40c. Thus, the battery cells 10 are fixed in a zigzag shape by the connection tabs 40a, 40b, and 40c formed on the first extender 20b and the second extender 20c, thereby preventing the battery cells 10 from moving. Further, the guide parts 47 disposed in a zigzag shape include guide grooves 47a, 47a′, and 47a″ (47a′ and 47a″ described below) and are welded with the lead wire 50 seated in the guide groove 47a, 47a′, and 47a″, thereby preventing the lead wire 50 from separating. That is, the battery pack has improved durability against impact, drop, and vibration.

Further, a welding process is conducted over the battery pack and this configuration improves workability of the welding process. Thus, it is easier to identify an unwelded part in the welding process, and a design margin is secured when combining the battery pack with an external case. In addition, a welded portion is disposed on an upper side of the battery pack, thereby inhibiting lead in the liquid state from flowing down to a lower part of the battery pack. Moreover, when the battery cells 10 are overheated and melt the welded portion and thus to cause separation of the lead wire 50, the lead wire 50 is caught in the through hole 45b, thereby inhibiting the lead wire 50 from separating.

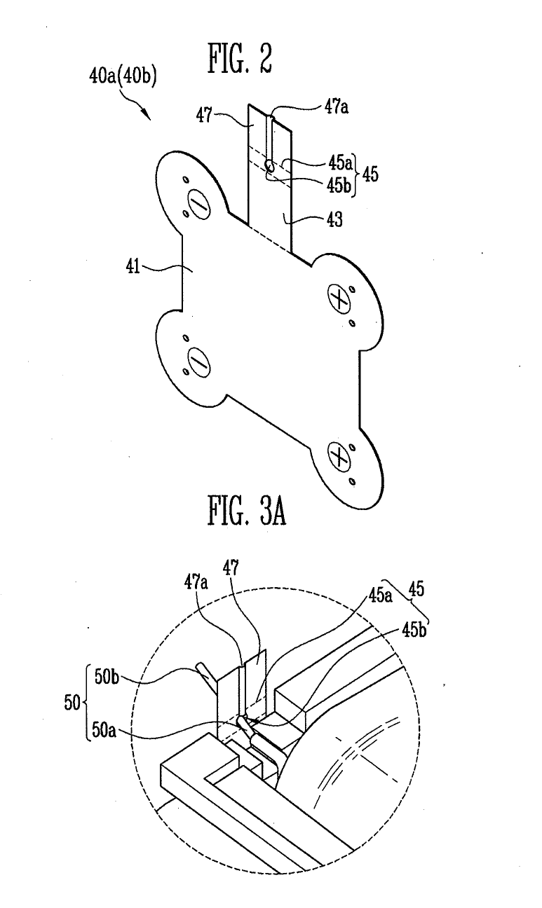

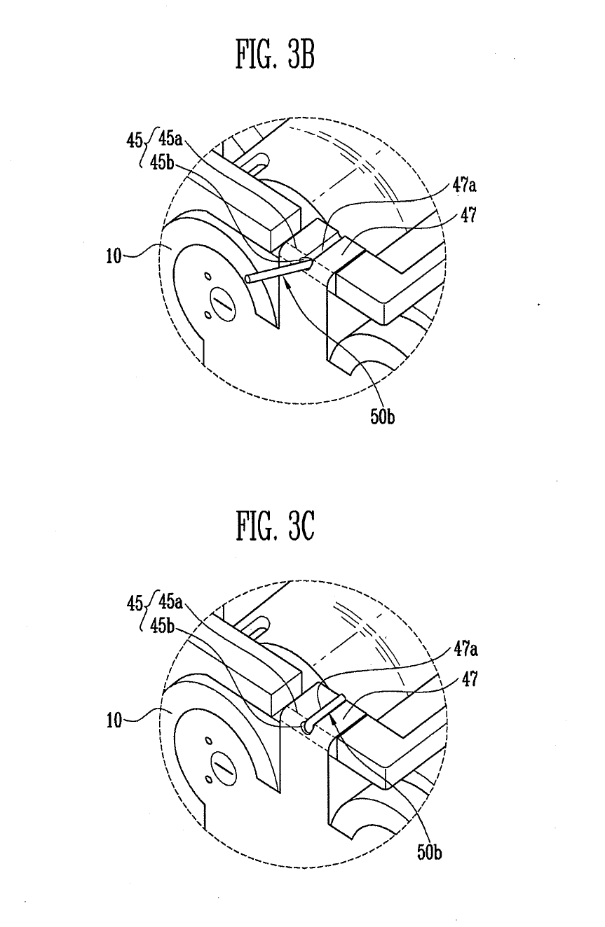

Referring to FIGS. 3A to 3C, a process of accommodating the lead wire in the connection tab according to the first embodiment of the present invention is described.

Referring to FIG. 3A, a part 50a of the lead wire 50 faces one side of the guide part 47 facing the battery cells 10. Accordingly, another part 50b of the lead wire 50 connected to the part 50a of the lead wire 50 passes through the through hole 45b. Then, referring to FIG. 3B, while the other part 50b of the lead wire 50 passes through the through hole 45b, the bent part 45 is bent toward the battery cells 10. Here, the other part 50b of the lead wire 50 passing through the through hole 45b protrudes in an opposite direction to the battery cells 10. Next, referring to FIG. 3C, the protruding other part 50b of the lead wire 50 is bent toward the battery cells 10 to be accommodated in the guide groove 47a of FIG. 3B, and then is welded.

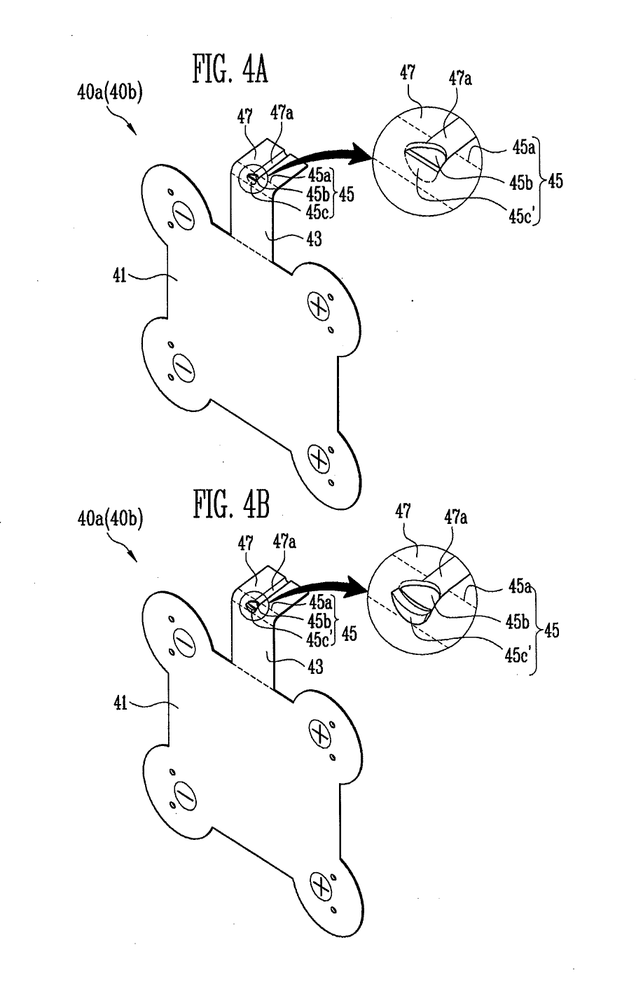

The through hole 45b generally has a circular shape, shown in FIG. 2. However, a connection tab 40 (40a and 40b) according to a second embodiment of the present invention may include a through hole 45b having a semicircular shape as shown in FIG. 4A as a through hole cover 45c′ covering part of the through hole 45b is provided in a direction of the extension part 43.

Further, referring to FIG. 4B, a connection tab 40 according to a third embodiment of the present invention includes a through hole cover 45c′ protruding outwards. These through hole covers 45c′ may be provided to reinforce relatively weak strength of an uncovered portion of a lead wire (not shown) as compared with a covered portion of the lead wire. In addition, the through hole covers 45c′ may readily guide the lead wire which passes through the through hole 45b and is bent at about 180° and accommodated in the guide groove 47a, 47a′, and 47a″.

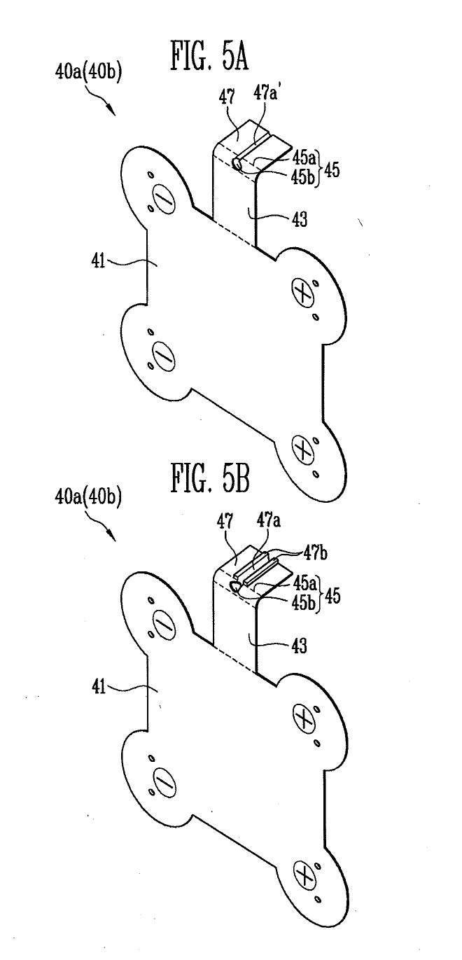

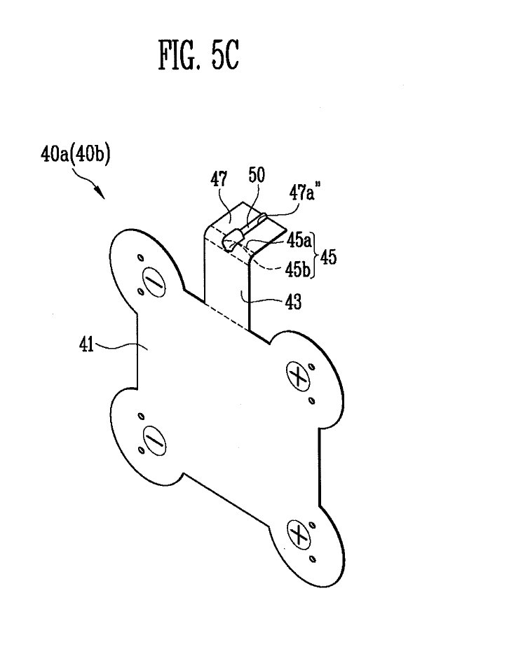

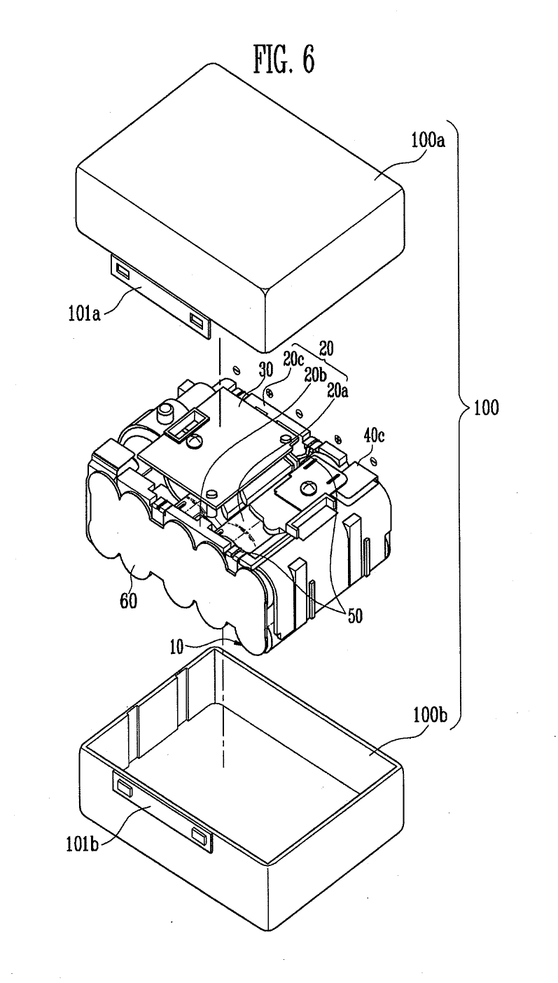

As described above, the guide groove 47a may be formed corresponding to the lead wire (not shown). However, referring to FIG. 5A, a connection tab 50 according to a fourth embodiment of the present invention may have a guide groove 47a′ having a narrow entrance so that a lead wire (not shown) is forcibly inserted into the guide groove 47a′. In this case, the lead wire 50 may be further stably accommodated.

Further, referring to FIG. 5B, a connection tab 40 according to a fifth embodiment of the present invention may further include a protrusion rib 47b around a guide groove 47a of a guide part 47. The protrusion fib 47b around the guide groove 47a may controls horizontal movement of a lead wire (not shown). Here, the protrusion rib 47b is provided to extend in a lengthwise direction of the guide groove 47a.

Further, a covered part surrounding the lead wire 50 may be bent. Referring to FIG. 5C, a connection tab 40 according to a sixth embodiment of the present invention may include a guide groove 47a″, a portion of which corresponding to a cover surrounding the lead wire 50 has the same area as the cover and a portion of which corresponding to the lead wire 50 has the same area as the lead wire 50.

FIG. 6 is a perspective view showing a battery pack including an external case according to the present invention.

Referring to FIG. 6, an external case 100 may be further provided around the holder case 20 covering the battery cell 10. The external case 100 may be divided into a first case 100a and a second case 100b, which may be coupled to each other. The first case 100a and the second case 100b are coupled by a groove 101a and a protrusion 101b, which are formed on the cases, respectively.

Though not shown in the drawings, the first case 100a and the second case 100b may be fixed by bolts or fitting. Also, a groove and a protrusion for coupling may be further formed on internal sides of the first case 100a and the second case 100b which face each other.

An insulating sheet 60 is provided to prevent contact between the connection tab 40 (see FIG. 1) connected with the first an second electrodes of the battery cells 10 by welding and the external case 100 which is the finish material. It is preferable that the insulating sheet 60 is made of a material having high thermal resistance in order to prevent damage by heat generated when current flows through the connection tab 40 or the lead wire 50.

Further, the protection module 30 may be installed at the cover 20a of the holder case 20. Electronic components are mounted on the protection circuit module 30, thereby constituting a protection circuit. The protection circuit module 30 is fixed to the holder case 20 by bolts, but may be fixed by other fasteners.

Although the cylindrical battery cells are used in the embodiments of the present invention, it should be noted that other shapes of battery cells may be used.

Although the spirit of the present invention was described in detail with reference to the preferred embodiments, it should be understood that the embodiments are provided only for explaining the present invention and the present invention is not limited thereto. Further, it should be understood that the present invention may be modified in various ways by those skilled in the art, without departing from the scope of the present invention.

The scope of the present invention described above is determined by the following claims and not limited to the detailed description described herein, and equivalent changes and modifications within claims are included in the spirit and scope of the present invention.

What is claimed is:

1. A battery pack comprising:
a plurality of battery cells having a first electrode and a second electrode that are disposed parallel to each other in a first direction;
a holder that receives the plurality of battery cells;
at least one lead wire that is coupled to the plurality of battery cells;
at least one connection tab that is electrically connected to at least some of the plurality of battery cells, wherein the connection tab has an extension part that comprises a guide groove that receives the at least one lead wire.

2. The battery pack of claim 1, wherein the at least one connection tab is planar and is mounted to an end of at least some of the plurality of the battery cells so as to extend in a second direction substantially perpendicular to the first direction.

3. The battery pack of claim 2, wherein the extension part is bent from the connection tab so as to extend substantially in the first direction.

4. The battery pack of claim 1, wherein the extension part includes a hole formed in the guide groove though which the at least one lead wire extends.

5. The battery pack of claim 4, wherein the extension part is bent at a connection point to the connection tab and is also bent at a second location wherein the extension part is positioned proximate to the holder and wherein the hole is formed adjacent the second location.

6. The battery pack of claim 4, wherein the extension part includes a through cover formed adjacent the hole such that the hole is semicircular in shape.

7. The battery pack of claim 6, wherein the through hole cover extends outward from the hole so as to reinforce the lead wire at the location of the hole.

8. The battery pack of claim 1, wherein at least a portion of the guide groove is dimensioned to be smaller than the outer dimension of the lead wire so that the lead wire is forcibly inserted into the guide groove and retained therein.

9. The battery pack of claim 1, wherein the extension tab further includes a protrusion rib that extends outward of the guide groove and controls horizontal movement of the at least one lead wire.

10. The battery pack of claim 1, wherein the at least lead wire includes an insulated portion and an uninsulated portion and wherein a portion of the guide groove adjacent the hole is dimensioned to be smaller than the insulated portion of the at least one lead wire.

11. A battery pack comprising:
a plurality of battery cells having a first electrode and a second electrode that are disposed parallel to each other in a first direction;
a holder that receives the plurality of battery cells;
a plurality of lead wires that are coupled to the plurality of battery cells;
a plurality of connection tabs that are electrically connected to the first and second electrodes of the plurality of battery cells, wherein each of the connection tabs have an extension part that defines a guide groove that receives one of the lead wires;
a protection circuit board that is mounted adjacent the holder and receives the plurality of lead wires from the battery; and
an external case that receives the plurality of batteries, the holder and the connection tabs.

12. The battery pack of claim 11, wherein the at least one connection tab is planar and is mounted to an end of at least some of the plurality of the battery cells on the first or second electrode so as to extend in a second direction substantially perpendicular to the first direction.

13. The battery pack of claim 12, wherein the extension part is bent from the connection tab on each of the connection tabs so as to extend substantially in the first direction.

14. The battery pack of claim 11, wherein the extension part of each of the connection tabs includes a hole formed in the guide groove though which the lead wire extends.

15. The battery pack of claim 14, wherein the extension part is bent at a connection point to the connection tab on each of the connection tabs and is also bent at a second location wherein the extension part is positioned proximate to the holder and wherein the hole is formed adjacent the second location.

16. The battery pack of claim 15, wherein the connection tabs and the extension parts are arranged over the holder so as to form a zig zag pattern between the first and second electrodes of the plurality of batteries.

17. The battery pack of claim 11, wherein at least a portion of each of the guide grooves is dimensioned to be smaller than the outer dimension of the lead wire so that the lead wire is forcibly inserted into the guide groove and retained therein.

18. The battery pack of claim 11, wherein each of the extension tab further includes a protrusion rib that extends outward of the guide groove and controls horizontal movement of the at least one lead wire.

19. The battery pack of claim 11, wherein the at least lead wire includes an insulated portion and an uninsulated portion and wherein a portion of the guide groove adjacent the hole is dimensioned to be smaller than the insulated portion of the at least one lead wire.

20. The battery pack of claim 11, further comprising an insulating sheet that is interposed between the connection tabs and the external case.
